(19) United States
(12) Patent Application Publication
(10) Pub. No.: US 2008/0087689 A1
(43) Pub. Date: Apr. 17, 2008

(54) Decanter And Doser For Liquids, In Particular For Wine

(75) Inventors: Heiko Mattern, Firenze (IT); Damiano Miniera, Firenze (IT)

Correspondence Address: HEDMAN & COSTIGAN P.C., 1185 AVENUE OF THE AMERICAS, NEW YORK, NY, 10036, US

(73) Assignee: Silvia Minera, Settignano (IT)

(21) Appl. No.: 11/665,443

(22) PCT Filed: Mar. 23, 2005
(86) PCT No.: PCT/EP05/03250

§ 371 Date: Sep. 10, 2007

(30) Foreign Application Priority Data
Oct. 12, 2004 (IT) F12004U000070

(51) Int. Cl. G01F 11/26

(52) U.S. Cl. 222/454

(57) ABSTRACT

A decanter and doser for liquids, in particular for wine, comprising an adapter (11) for the mouth of a bottle (16) from which a T-terminating tubular element (12) extends, of which one end is equipped with an outward opening (17), with a possible closing (15), and an opposite end has an enlarged element (19) for the closed containment of a pre-established volume.

The present invention relates to a decanter and doser for liquids.

In the use of liquid food products, such as oils, vinegar, syrups, alcoholic and strong alcoholic drinks, and the like, it is frequently necessary to measure a specific quantity of liquid.

Furthermore, the liquid to be measured and used in the pre-established quantity must be decanted for problems of use. This necessity is particularly present in the pouring of wines, alcoholic and strong alcoholic liquids, as a re-oxygenation of the product before consumption is required for appreciating their quality.

These operations are currently effected with a certain difficulty or with particularly complicated devices. In the serving of wine, for example, the product must be re-oxygenated before consumption and this is normally achieved by decanting all the contents of a bottle in a suitable decanter. This operation, however, requires that the wine be consumed within a short period of time, otherwise it loses its quality.

An objective of the present invention is to provide a device which solves the technical problems described above, and in particular which can be used as both a decanter and a doser.

A further objective is to provide a device of the type indicated above which is particularly simple and inexpensive, and can also be firmly positioned on the container and/or bottle with closing functions.

Yet another objective is to provide a decanting-supply device which avoids pouring the liquid into a decanter, before consumption, which in this case must be effected in extremely reduced times.

These objectives according to the present invention, are achieved by producing a decanter and doser for liquids, in particular for wine, as illustrated in claim 1.

Further characteristics of the invention are specified in the subsequent claims.

The characteristics and advantages of a decanter and doser for liquids, in particular for wine, according to the present invention, will appear more evident from the following illustrative and non-limiting description, referring to the enclosed schematic drawings, in which:

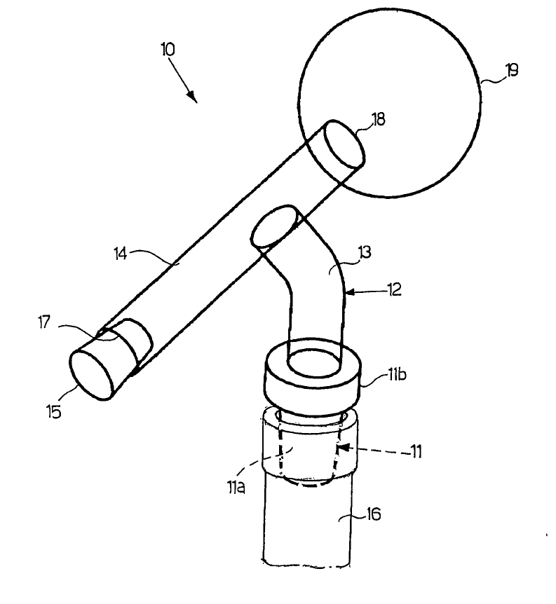

FIGURE 1 shows a perspective view of a decanting and dosing device for liquids, in particular wine, according to the invention.

With reference to the figures, these show a decanter and doser for liquids, in particular for wine, according to the invention and indicated as a whole with 10.

The decanter and doser comprises an adapter 11 for a mouth of a bottle, partially shown in 16, from which a T-terminating tubular element 12 extends. The adapter 11 can have a first portion 11a, which has a truncated-conical shape, suitable for being inserted in the mouth of the bottle, and a second ring portion 11b with an enlarged diameter suitable for resting on the mouth of the bottle. In the example, the tubular element 12, made of glass or an equivalent material, has a first essentially vertical portion 13, terminating with a second essentially horizontal portion 14, which intersects with the first portion. The second portion 14 has an outward opening 17 at a first end, with a possible closing, such as a stopper 15. A second end 18, opposite the first end, is provided with an enlarged element 19 for the closed containment of a pre-established volume. In the example illustrated, said enlarged element is in the form of a sphere, but can have any other shape, such as an ellipsoid (egg-shaped), a cube with rounded edges, etc.

As mentioned above, the enlarged element 19 defines a pre-established volume which has the double function of measuring a desired quantity of liquid and also decanting. In particular, the decanting operation is easily effected as the second portion 14 of the tubular element 12 can be connected to the opening 17 which allows oxygen to enter inside, with consequent contact with the liquid contained therein.

The presence of the stopper 15, situated in correspondence with the outward opening 17, allows the desired quantity of oxygen to enter the decanter when the bottle is used.

Contemporaneously, in the case of non-use, the repositioning of the stopper avoids deterioration of the liquid contained in the bottle, and also prevents the entrance of foreign bodies. The stopper can be advantageously made of cork, cork-silicone, or any other material suitable for food products. The same materials can also be used for the adapter 11 which is inserted into the mouth of the bottle 16, after it has been opened.

The use of the decanter-doser for liquids according to the invention is evident.

When this device is used for pouring wine into glasses, it allows a first re-oxygenation of the product which has passed inside the sphere l9, also for serving a single portion or dose.

As already mentioned above, as said device 10 according to the invention, can be applied directly to the bottle, it allows the product to be kept integral still preserved in the original container.

The formation in a device according to the invention of an enlarged element 19 for the closed containment of a pre-established volume, allows the exact measurement of a dose to be served, which coincides with the size of said element, thus avoiding the pouring of an excessive amount. The particular simplicity of the device of the invention also allows it to be available within a wide range by simply varying the volume of the enlarged element 19 which can be produced, for example, within the range of 20 ml, 50 ml, 80 ml, 100 ml, etc.

It can thus be seen that a decanter and doser for liquids according to the present invention achieves the objectives specified above.

The decanter and doser for liquids of the present invention thus conceived can undergo numerous modifications and variants, all included within the scope of the inventive concept.

Furthermore, in practice, the materials used as also the dimensions and components can vary according to technical demands.

1. A decanter and doser for liquids, in particular for wine, comprising an adapter (11) for the mouth of a bottle (16) from which a T-terminating tubular element (12) extends, of which one end is equipped with an outward opening (17), with a possible closure (15), and an opposite end has an enlarged element (19) for the closed containment of a pre-established volume.

2. The decanter and doser for liquids according to claim 1, characterized in that said tubular element (12) comprises an essentially vertical first portion (13) terminating with an essentially horizontal second portion (14) which intersects with the first portion, said second portion (14) having at opposite ends said opening (17) and said enlarged element (19).

3. The decanter and doser for liquids according to claim 1, characterized in that said enlarged element (19) is in the form of a sphere.

4. The decanter and doser for liquids according to claim 1, characterized in that said enlarged element (19) is in the form of a sphere with a varying volume.

5. The decanter and doser for liquids according to claim 1, characterized in that it is made of glass in said tubular element (12).

6. The decanter and doser for liquids according to claim 1, characterized in that it is made of cork, cork-silicone or any other suitable material in said adapter (11).

7. The decanter and doser for liquids according to claim 1 or 6, characterized in that said adapter (11) has a first truncated-conical-shaped portion (11a) suitable for being inserted into the mouth of the bottle, and a second ring portion (11b) with an enlarged diameter suitable for resting on the mouth of the bottle (16).
